(19) United States
(12) Patent Application Publication
(10) Pub. No.: US 2023/0274756 A1
(43) Pub. Date: Aug. 31, 2023

(54) DYNAMICALLY CHANGING AUDIO PROPERTIES

(71) Applicant: Apple Inc., Cupertino, CA (US)

(72) Inventors: Shai MESSINGHER LANG, Santa Clara, CA (US); Christopher T. EUBANK, Santa Barbara, CA (US); Stephen E. PINTO, Mountain View, CA (US); Kacper KOSIKOWSKI, San Francisco, CA (US); James BEAN, Portland, OR (US); Matthew S. CONNOLLY, San Jose, CA (US); David E. ROMBLOM, Boulder, CO (US)

(21) Appl. No.: 18/110,298

(22) Filed: Feb. 15, 2023

Related U.S. Application Data
(63) Continuation of application No. PCT/US2021/045969, filed on Aug. 13, 2021.
(60) Provisional application No. 63/172,963, filed on Apr. 9, 2021.
(60) Provisional application No. 63/073,175, filed on Sep. 1, 2020.

(51) Int. Cl. G10L 25/03; G10L 21/02

(52) U.S. Cl. CPC G10L 25/03; G10L 21/02

(57) ABSTRACT

An object can represent computer applications that play audio. Audio parameters associated with the audio can be determined based on size of the object so that when the object is large, the audio sounds like it originates from a large sound source or sources. When the object is small, the audio parameters are determined so that the audio sounds like it originates from a small sound source. Other aspects are described.

### CROSS REFERENCE

This application claims the benefit of the U.S. Provisional application No. 63/073,175 filed Sep. 1, 2020 and 63/172,963 filed Apr. 9, 2021.

### FIELD

One aspect of the disclosure relates to dynamically changing audio properties that are associated with an application.

### BACKGROUND

Computer systems, including mobile devices or other electronic systems, can run one or more applications that play audio to a user. For example, a computer can launch a movie player application that, during runtime, plays sounds from the movie to the user. Other applications, such as video calls, phone calls, alarms, and more, can be associated with audio playback.

An operating system can present a user interface or display to a user that shows one or objects to a user, where that object (e.g., an icon, a window, a picture, an animated graphic, etc.) is representative of the application. For example, a movie player application may play in a ‘window’ that allows the user to view and control playback. Operating systems can manage multiple applications at a given time.

### SUMMARY

System level rules can be enforced for adjusting audio parameters of an application based on size of an object. The object, e.g., an icon, a window, a picture, an animated graphic, etc., can represent the underlying application. The object can be presented on a 2D display, or as a virtual object in an extended reality (XR) environment.

Further, audio that is associated with the application can be rendered spatially so that the object represents one or more sound sources. For example, if a media player window is presented to a user that shows a movie, and the media player window is shown as a small window, then the audio parameters can be determined so that audio that is associated with the media-player window (e.g., a movie audio track) is rendered so as to be perceived to originate from a small source. If a user adjusts a size of the media player window to be bigger, then audio parameters are dynamically adjusted to reflect the size of the window. In this case, the movie audio can sound like it originates from a larger, more complex, or impressive sound source. Audio parameters that are determined based on object size can include, for example, dynamic range, directivity pattern, frequency response, sound power, and/or other audio parameters.

In some aspects, a method, system or computing device that performs the method is described. The method includes maintaining metadata associated with one or more applications. The metadata specifies a size of an object (e.g., an icon, a window, a picture, a computer generated graphic, an animation, and/or other object) that is associated with the application. The object is presented to a user, for example, on a display. Based on a size of the object, one or more audio parameters are determined or modified. An audio parameter can include at least one of: a dynamic range, a directivity pattern, a frequency response, a sound power, a frequency range, a pitch, a timbre, a number of output audio channels, and a reverberation.

The audio parameter can be applied to render and/or mix audio that is associated with the application. In such a manner, objects that are shown to a user that appear to be large can also sound as if they are large (e.g., multiple sound sources, large dynamic range, bass, etc.). Conversely, objects that are shown to a user that are tiny can sound tiny (e.g., a single point source, small dynamic range, etc.). By enforcing these rules, real world acoustic behaviors of objects are mimicked to maintain plausibility. A user can also resize objects to make them sound ‘bigger’ or ‘smaller’. The system level rules can be enforced at an operating system level. In some aspects, these rules can be enforced on multiple applications concurrently.

The above summary does not include an exhaustive list of all aspects of the present disclosure. It is contemplated that the disclosure includes all systems and methods that can be practiced from all suitable combinations of the various aspects summarized above, as well as those disclosed in the Detailed Description below and particularly pointed out in the Claims section. Such combinations may have particular advantages not specifically recited in the above summary

### BRIEF DESCRIPTION OF THE DRAWINGS

Several aspects of the disclosure here are illustrated by way of example and not by way of limitation in the figures of the accompanying drawings in which like references indicate similar elements. It should be noted that references to “an” or “one” aspect in this disclosure are not necessarily to the same aspect, and they mean at least one. Also, in the interest of conciseness and reducing the total number of figures, a given figure may be used to illustrate the features of more than one aspect of the disclosure, and not all elements in the figure may be required for a given aspect.

FIG. 1 illustrates a method for rendering audio with dynamic audio parameters, according to some aspects.

FIG. 2 shows an operating system workflow for rendering audio with dynamic audio parameters, according to some aspects.

FIG. 3 and FIG. 4 show audio adjustment based on size of an object, according to some aspects.

FIG. 5 shows an example of objects on display that represent applications and sound sources, according to some aspects.

FIG. 6 shows an example of a directivity pattern.

FIG. 7 shows an example of dynamic range.

FIG. 8 shows an example of frequency control.

FIG. 9 shows an example audio processing system, according to some aspects.

FIG. 10 shows an example of generating sound based on a model of a sound source, according to some aspects.

### DETAILED DESCRIPTION

Several aspects of the disclosure with reference to the appended drawings are now explained. Whenever the shapes, relative positions and other aspects of the parts described are not explicitly defined, the scope of the invention is not limited only to the parts shown, which are meant merely for the purpose of illustration. Also, while numerous details are set forth, it is understood that some aspects of the disclosure may be practiced without these details In other instances, well-known circuits, algorithms, structures, and techniques have not been shown in detail so as not to obscure the understanding of this description.

A person can interact with and/or sense a physical environment or physical world without the aid of an electronic device. A physical environment can include physical features, such as a physical object or surface. An example of a physical environment is physical forest that includes physical plants and animals A person can directly sense and/or interact with a physical environment through various means, such as hearing, sight, taste, touch, and smell. In contrast, a person can use an electronic device to interact with and/or sense an extended reality (XR) environment that is wholly or partially simulated. The XR environment can include mixed reality (MR) content, augmented reality (AR) content, virtual reality (VR) content, and/or the like. With an XR system, some of a person's physical motions, or representations thereof, can be tracked and, in response, characteristics of virtual objects simulated in the XR environment can be adjusted in a manner that complies with at least one law of physics. For instance, the XR system can detect the movement of a user's head and adjust graphical content and auditory content presented to the user similar to how such views and sounds would change in a physical environment. In another example, the XR system can detect movement of an electronic device that presents the XR environment (e.g., a mobile phone, tablet, laptop, or the like) and adjust graphical content and auditory content presented to the user similar to how such views and sounds would change in a physical environment. In some situations, the XR system can adjust characteristic(s) of graphical content in response to other inputs, such as a representation of a physical motion (e.g., a vocal command)

Many different types of electronic systems can enable a user to interact with and/or sense an XR environment. A non-exclusive list of examples include heads-up displays (HUDs), head mountable systems, projection-based systems, windows or vehicle windshields having integrated display capability, displays formed as lenses to be placed on users' eyes (e.g., contact lenses), headphones/earphones, input systems with or without haptic feedback (e.g., wearable or handheld controllers), speaker arrays, smartphones, tablets, and desktop/laptop computers. A head mountable system can have one or more speaker(s) and an opaque display. Other head mountable systems can be configured to accept an opaque external display (e.g., a smartphone). The head mountable system can include one or more image sensors to capture images/video of the physical environment and/or one or more microphones to capture audio of the physical environment. A head mountable system may have a transparent or translucent display, rather than an opaque display. The transparent or translucent display can have a medium through which light is directed to a user's eyes. The display may utilize various display technologies, such as uLEDs, OLEDs, LEDs, liquid crystal on silicon, laser scanning light source, digital light projection, or combinations thereof. An optical waveguide, an optical reflector, a hologram medium, an optical combiner, combinations thereof, or other similar technologies can be used for the medium. In some implementations, the transparent or translucent display can be selectively controlled to become opaque. Projection-based systems can utilize retinal projection technology that projects images onto users' retinas. Projection systems can also project virtual objects into the physical environment (e.g., as a hologram or onto a physical surface).

Various examples of electronic systems and techniques for using such systems in relation to various XR technologies are described.

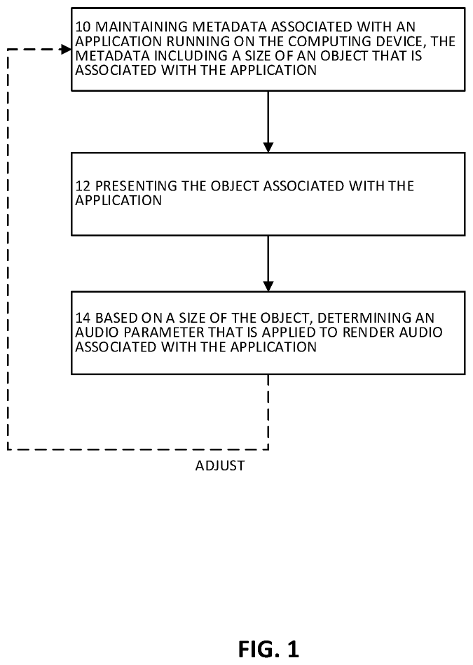

Referring to FIG. 1, a method is shown for adjusting audio parameters based on the size of an object. The method can be performed by an apparatus (e.g., a computing device). In some aspects, the method is performed by an operating system of a computing device. The operating system can manage one or more applications that are running on the computing device. In some aspects, the operating system manages audio processing of each application, which can include spatial rendering, downmixing, upmixing, filtering, etc.

The operating system can manage objects (e.g., user interface elements) that are shown to a user. Each of the objects can be associated with or represent a corresponding application. In some aspects, the object represents an actively running application (e.g., an open media player window) rather than a selectable icon that, when selected, causes the operating system to launch an application.

At operation 10, the method includes maintaining metadata associated with an application running on the computing device, the metadata including a size of an object (e.g., a user interface object) that is associated with the application. For example, the metadata can include dimensions of a media player window that is being shown to a user. In some aspects, the metadata can include the position of the object relative to display coordinates, which can vary from one display environment to another.

At operation 12, the method includes presenting the object associated with the application. In some aspects, the object is presented through a two-dimensional display, such as, for example, a computer monitor, a television, a display of a tablet computer, a mobile phone, or other two-dimensional display. In some aspects, the object is presented on a device that supports three-dimensional XR, such as, for example, a head mounted display, a head-up display, or other equivalent technology. In some aspects, a user or user head position is tracked relative to objects and spatial audio is rendered based on the tracked position.

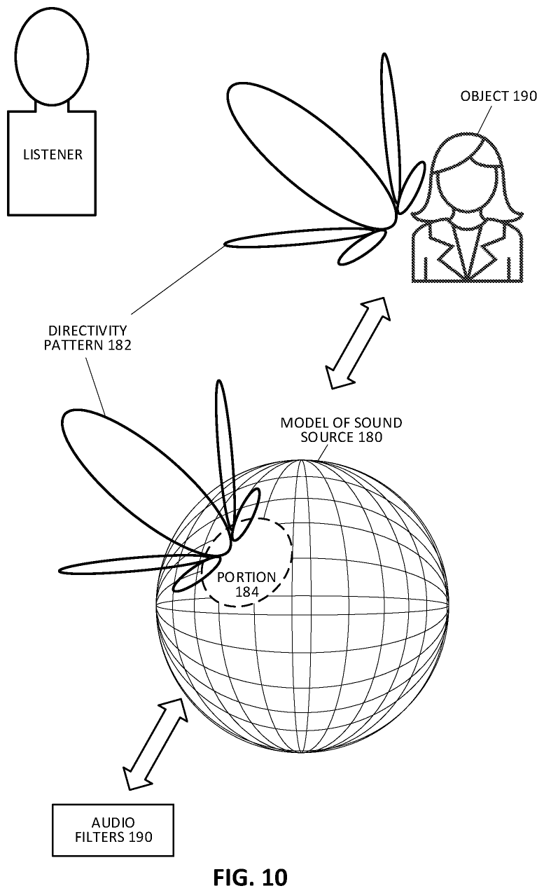

At operation 14, the method includes determining an audio parameter based on a size of the object. The audio parameter is applied to render audio associated with the application. The audio parameter, in some cases, includes at least one of a dynamic range, a directivity pattern, a frequency response, a sound power, a frequency range, a pitch, a timbre, a number of output audio channels (or a channel layout), and a reverberation. In some aspects, as described in greater detail below with respect to FIG. 10, the audio parameter includes one or more parameters of a model used to render the application or sound source, or one or more audio filters derived from an acoustic simulation using the model.

In some aspects, at operation 14, the method includes determining at least two audio parameters based on size of the object, where one of the at least two audio parameters is a sound power, and at least one other of the at least two audio parameters includes a dynamic range, a directivity pattern, a frequency response, a frequency range, a pitch, a timbre, a number of output audio channels, and a reverberation. The determination (or adjustment) of sound power and at least one other audio parameter can enhance a perceived relationship between the size of the object and audio that is associated with the object.

In some aspects, the method can be performed continuously to dynamically determine or modify one or more of the of the plurality of audio parameters if the size of the object is modified. In some aspects, size of the object can be modified through a user input. A user input can be received from an input device such as a touch screen display, a mouse input, an XR user input sensor (e.g., recognizing hand gestures with computer vision and/or 2D or 3D image sensor technology), or input device. In some aspects, the size of the object can be automatically modified (e.g., based on an automated rearrangement of active ‘windows’). The method can be performed by an operating system that manages one or more applications.

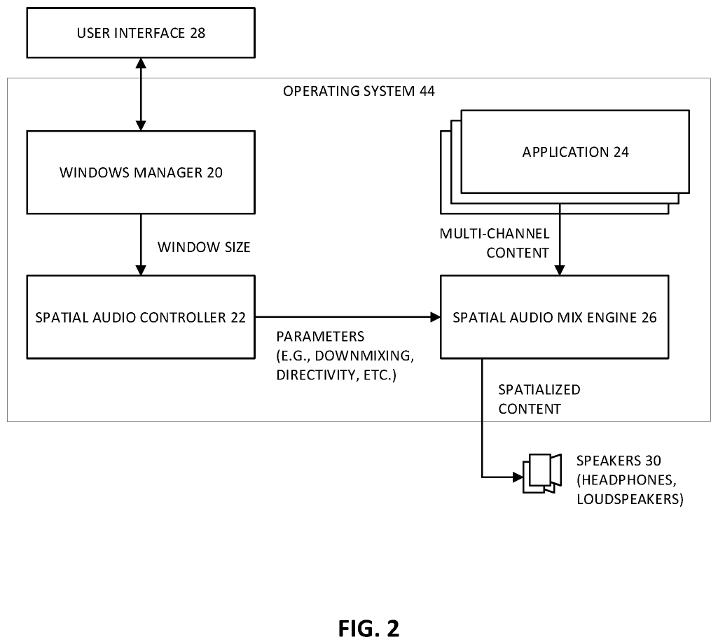

As shown in FIG. 2, an operating system 44 can be present on a computing device to manage computing tasks and one or more applications 24. The operating system can include a windows manager 20 that manages one or more objects that are representative of the applications (e.g., active applications). These objects can be shown on a user interface 28, which, as described, can include a two dimensional display or an XR display that can incorporate elements in a user's physical environment. The user interface can include one or more input devices such as a mouse, computer keyboard, touchscreen display, camera, image sensors, and other technology that allows a user to provide inputs such as inputs relating to resizing of the one or more objects.

The windows manager can manage metadata of each of the applications, which can include a size of the object that represents the application. Based on the size of the object (e.g., a size of an active window), the spatial audio controller 22 can determine one or more audio parameters as described in other sections, that are applied to audio content of the application.

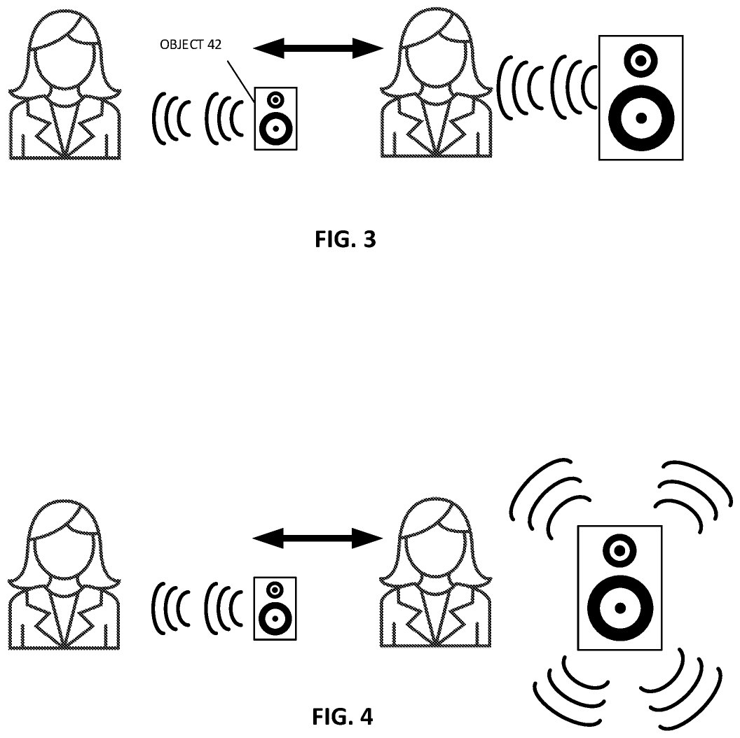

For example, as shown in FIG. 3, if an object 42, which represents an application, has a large size, or is increased, the sound power can be increased. If the object 42 is decreased or has a small size, then the sound power can be decreased. In some aspects, as shown in FIG. 4, the size of the object can increase the sound power, as well as how the sound is output, such as dynamic range, a directivity pattern, a frequency response, a frequency range, a pitch, a timbre, a number of output audio channels, and a reverberation.

Referring back to FIG. 2, a spatial audio mix engine 26 can apply these audio parameters to the audio content and perform audio mixing for one audio application or multiple applications if multiple applications are running on the operating system. The spatial audio mix engine can generate one or more output audio channels that are used to drive speakers 30. The output audio channels can have various output audio formats, for example, binaural audio (having a left and right channel), 5.1, 7.2, Atmos, or other audio format. The speakers can be speakers of a headphone set, integrated with a head mounted display, one or more loudspeakers, one or more speaker arrays, or other speaker arrangement.

In some aspects, these audio parameters are independent of other controls that affect audio parameters. For example, user-level controls can allow for increase and decrease in volume, or modifications to bass, treble, etc. This can be independent of the audio parameters that are determined based on size of the object.

Further, application audio can have metadata that describes configured audio settings such as dynamic range, loudness, frequency range, channel layout, etc. This application level metadata can also be independent of the audio parameters that are determine based on object size.

In some aspects, if there is a conflict between the user level controls, the audio parameters based on object size, or the application level metadata, the operating system arbitrates to determine how audio is rendered based on the competing audio parameters. This arbitration can apply one or more algorithms or logic that is capable of being determined and adjusted based on routine test and experimentation.

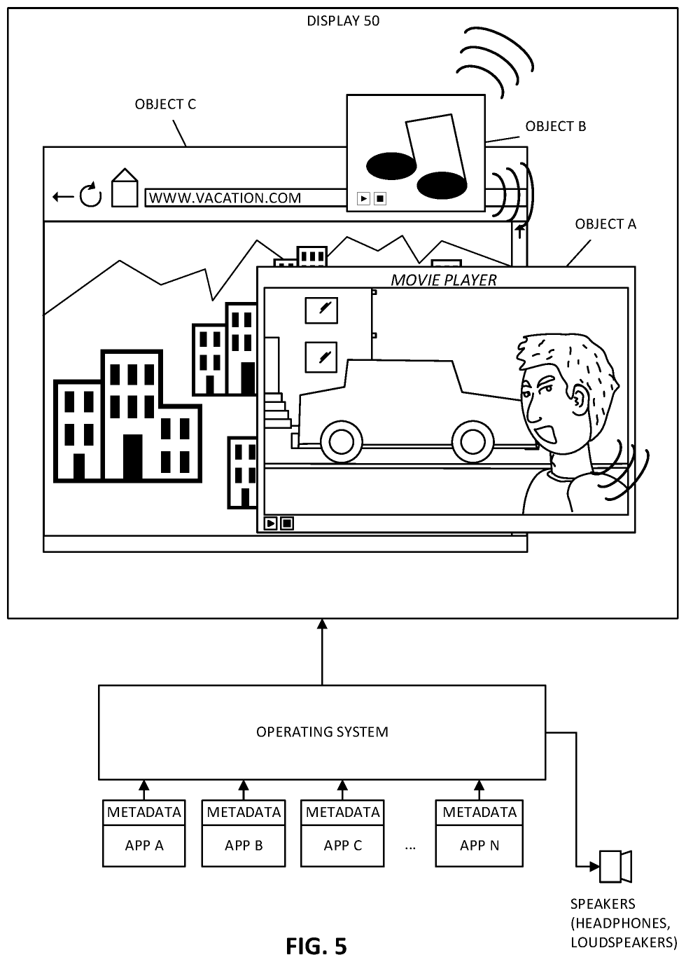

FIG. 5 shows an example of objects representative of applications, according to some aspects. Various objects are shown on a display 50, which can be any of the displays discussed in the present disclosure. Applications and their associated metadata are managed by the operating system. The operating system can access the metadata which includes size of an object that is associated with the application. The operating system can monitor size of each object associated with each application and determine or modify audio parameters based on size of each object. Each object can have dedicated audio parameters that are paired to that object (and the underlying application). In other words, application A can have its own audio parameters that are determined based on size of object A. Independently, application B can have its own audio parameters that are determined based on size of object B.

For example, object A can represent audio of application A, which is a media player. On the same display, object B can be representative of application B, which is a music player. Object C can be representative of application C, which is a web browser. Each of these applications can be actively running and managed by the operating system. Audio that is associated with one or more of the applications can be played through the speakers. Based on size of the movie player window, music player, and web browser, their corresponding audio parameters can be determined.

If the size of the movie player is small, the audio parameters of the audio content associated with the movie player can be ‘small’ sounding. If the size of the movie player is large, the audio content associated with the movie player can have a ‘large’ sound. The size of objects can be changed (e.g., automatically by the operating system, or through user input). The audio parameters can adjust accordingly based on the updated size of the objects. Thus, if the object size is increased, the audio parameters can be adjusted so that associated audio sounds larger. Conversely, if the object size is decreased, the audio parameters can be adjusted so that the audio sounds smaller The audio output for each of the applications can be rendered separately and then combined to form output audio channels that are used to drive output speakers to produce sound.

As discussed, audio parameters are determined based on size of an object associated with application audio. These audio parameters can include one or more of a dynamic range, a directivity pattern, a frequency response (e.g., an on-axis frequency response), a sound power, a frequency range, a pitch, a timbre, a number of output audio channels, and a reverberation.

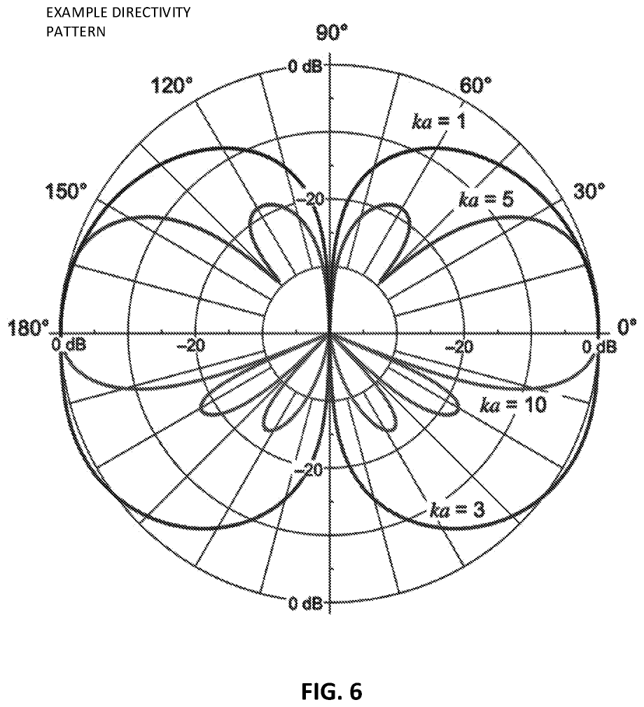

FIG. 6 shows an example of a directivity pattern (also known as an off-axis frequency response, a field pattern, or a polar pattern) of a sound source. This example directivity pattern is shown in “Acoustics: Sound Fields and Transducers”, by Leo Beranek and Tim Mellow. The perceived sound of a sound source can vary relative to direction and distance from the sound source. A directivity pattern for an object defines how a sound source's frequency response varies at off-axis angles. In this example, a directivity pattern is shown for an objects, where frequency is plotted on a normalized scale, and ka (k being wavenumber and a being a characteristic dimension of the source such as a radius) can be represented by 2πa/λ, 2πfa/c, which is circumference divided by wavelength. Directivity index is shown for each directivity pattern, the directivity index being a difference (e.g., measured in decibels) between the sound pressure level from the measured sound pressure level in a given direction from the source, and the average sound pressure level of the sound source modeled as an omnidirectional source. It should be understood that the example directivity pattern of FIG. 6 is shown to illustrate a directivity pattern of a sound source rather than to limit aspects of the present disclosure to a particular directivity pattern. Directivity patterns can vary, for example, based on content or application, without departing from the scope of the present disclosure.

In some aspects, the directivity pattern associated with audio of an application is determined based on size of an object. For example, if an object is a virtual guitar is small, the directivity pattern can have a reduced number of lobes or be omnidirectional. In the case of an omnidirectional directivity pattern, audio associated with the virtual guitar can be spatially rendered equally in all directions around the virtual guitar. If the virtual guitar is large, however, then the directivity pattern can have an increased number of lobes or variance, giving the spatially rendered audio more variance at different directions relative to the virtual guitar. In the case of XR, the directivity pattern can mimic a directivity pattern of a physical guitar.

In some aspects, the directivity pattern becomes more directional (e.g., narrower or more concentrated in one or more directions) as the size of the object is increased and becomes more omnidirectional (e.g., round or equal in all directions) as the size of the object decreases. For a single chosen frequency, a physical object that is acoustically small for low frequencies can be acoustically large for high frequencies. Also, an object that is acoustically large for low frequencies can also be acoustically large for high frequencies. An acoustically small object can be defined as an object the size of which is small compared to the wavelength of the radiated sound wave. If an object is acoustically small, it is “invisible” to the wave - the effect of reflection and diffraction can be ignored, the shape and presence of the sound source does not affect the radiation pattern, and the source can be treated as a monopole (omnidirectional). As such, an acoustically small object can represent a large source at a very small frequency, or a tiny source at a high frequency. An acoustically large object is an object the size of which is much greater than wavelength of the radiated sound wave. The object and its geometry becomes visible to the wave (for example, an asymptotically large object will be seen as close to an infinitely large wall reflecting the sound) and has effect on the radiation pattern of sounds emitted from it. In such case, the source can become more directional. This relationship can be imagined as the source's body casting a shadow towards the back of the source, not letting the acoustic energy to the back, and radiating a bigger part of it to the front.

To a wave typically referred to as “low-frequency” (e.g. a frequency of 100 Hz, wavelength of which is equal to 3.43 meters (air, normal conditions)), an object with dimensions much smaller than its wavelength value (e.g. a cubical loudspeaker with a driver on one wall, with an edge length of a few dozen centimeters) will be acoustically small (invisible), thus yielding an omnidirectional pattern. If a “high-frequency” wave is under consideration (e.g. a frequency of 8 kHz, the wavelength is equal to 4.3 centimeters), the same example cubical loudspeaker will be acoustically large, yielding a more directional pattern. If the same example cubical loudspeaker gets larger, at some point it will become acoustically large for the low frequency. In such a case, the pattern will no longer be omnidirectional and the high frequency pattern will become even more directional than before.

Multiplication of the wavenumber k (k=2*Pi*frequency/speed of sound) with the characteristic dimension of the source ‘a’ (e.g. the radius of a sphere enclosing the physical asset or the radius of the source's membrane) can determine if an object is acoustically small or acoustically large. When the ka value of an object is small, the object is acoustically small When the ka value is large, the object is acoustically large. The smaller the ka value, the more omnidirectional the source. The larger the ka value, the more directional the source.

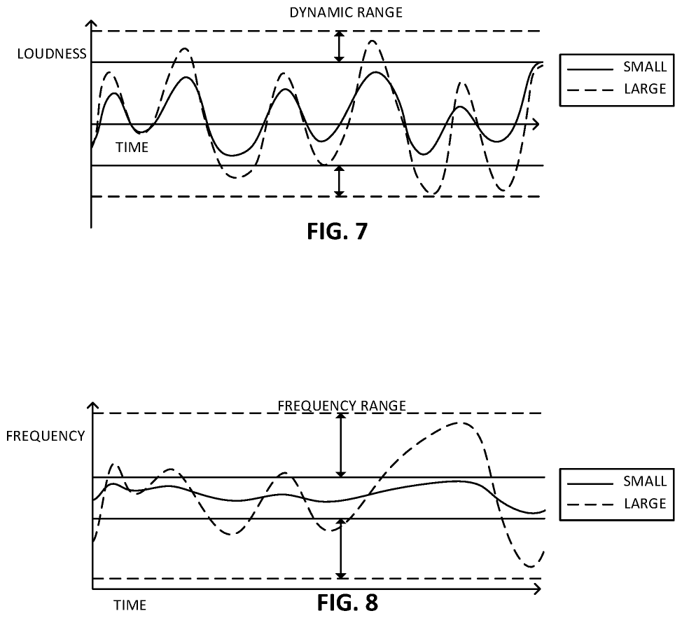

FIG. 7 shows an example of dynamic range. Dynamic range, dynamic range compression, or compression, refers to a range of loudness that a sound source can have. Loudness of an audio signal can vary over time. One or more gains can be applied to an audio signal to amplify or compress the maximum and minimum sound level of the signal, so that the audio can be heard at a comfortable level at both the maximum and minimum levels.

In some aspects, if the size of the object is small, then the dynamic range has a reduced range. If the size of the object is large, then the dynamic range has an increased range. In this manner, if the object size increases, the envelope with which you can hear the sound is larger (meaning that audio that is associated with the object can become louder and quieter). Conversely, if the object is small, then the audio that is associated with the object will be limited to a smaller range. Additionally, or alternatively, the dynamic range can be offset (e.g., raised or lowered) based on size of object. For example, an offset of the sound raised so that the both maximum and minimum levels of audio are higher when the object is large, and/or lowered when the object is small

In some aspects, frequency response (e.g., an on-axis frequency response) of audio associated with an object is determined based on the object size. Frequency response can be the quantitative measure of the output spectrum of a system or device in response to a stimulus, and is used to characterize the dynamics of the system. Frequency response can be represented as a measure of magnitude and phase of audio output of a system as a function of frequency, as compared to the audio input of the system. On-axis frequency refers to the frequency response of the sound source on the sound source's axis (e.g., at its origin) as opposed to the off-axis frequency response of the sound source, which can vary as a function of direction and frequency. The frequency response can be determined to mimic frequency responses of a large sound source when the object is large. Conversely, the frequency response can be determined to mimic frequency response of a small sound source when the object is small.

In some aspects, the frequency response (e.g., on-axis frequency response) is changed if the size of the object is modified, such that a low frequency cut-off for the audio is raised if the size of the object is decreased and the low frequency cut-off for the audio is lowered if the size of the object is increased. This effectively cuts off more frequencies below the frequency cut-off. The on-axis sound pressure in the far field (which can be referred to as the level of the source) depends on the volume velocity generated by a loudspeaker's vibrating diaphragm. As the diaphragm oscillates back and forth (assuming sinusoidal displacement), both of those quantities depend on the amplitude of the diaphragm's displacement (in meters) and the time that it takes for it to achieve that displacement. Each of the frequencies are characterized by its period, inverse to the frequency value. A half of this period is the time in which the diaphragm must move from its minimum to its maximum displacement. For high frequencies, the period is very short. In such a case, to achieve a high velocity the displacement of the diaphragm does not have to be large. For low frequencies, the period is very long. In such a case, to achieve a high velocity, the displacement of the diaphragm must be large. Volume velocity is a value obtained by multiplying the surface area of the diaphragm and its velocity. The sound pressure in the far field is proportional to the volume velocity.

Large sources have large diaphragm surface areas, which, in combination with their physical construction that facilitates larger displacements, allows them to be good low frequency radiators. Small sources have small diaphragm surface areas. In order to generate sufficient amounts of low frequency energy, the displacement of the diaphragm would have to be very large—which is physically difficult for tiny objects. For example, a small cube with an edge of a few centimeters having a diaphragm moving back and forth by a dozen centimeters, would be unnatural and structurally implausible. Therefore, the system can simulate inability of small sources to generate low frequency energy. The smaller the source, the higher its cut-off frequency (no sound below this cut-off frequency).

As discussed, sound power (also known as acoustic power) of audio can be determined based on the object size. Sound power refers to a power of acoustic energy emitted from a sound source, irrespective of an environment (e.g., a room) of the sound source, which can have an effect on the sound pressure level that measures the sound power in the environment. Sound power can be measured as the rate at which sound energy is emitted (or in some cases, reflected, transmitted or received), per unit time. If an object is small, the sound power of the audio that is associated with the object can be determined to be small. If the object is large, the sound power of the audio object can be determined to be large.

In some aspects, frequency range of audio can be determined based on the object size. For example, as shown in FIG. 8, a large frequency range can be determined for audio that is associated with a large object. Conversely, a small frequency range can be determined for audio that is associated with a small object. The frequency range can represent the maximum and minimum frequency of the audio. A larger sound source can be expected to have greater range in audio frequency (e.g., more bass, more treble), while smaller sound sources can have less range and sound flatter. Thus, increasing object size can increase the frequency range of audio associated with the object, and decreasing the object size can decrease the frequency range of the audio.

In some aspects, pitch of audio is determined based on the object size. Pitch refers to a perceived quality of how high or low a sound is and relates to a frequency of the sound. The higher the frequency of a sound, the higher the pitch. In some aspects, a pitch is determined as higher for smaller objects, and lower for larger objects. In some aspects, bass of audio is determined based on the object size. For example, lower frequencies (e.g., in the bass range) can be introduced or emphasized when the object is large, and de-emphasized when the object is small

In some aspects, a number of output audio channels or a channel layout associated with audio is determined based on the size of the object. For example, if an object is small, the output audio channel can be a single audio channel (e.g., mono). If the object size is large or increased, the output audio channels can include binaural audio having spatialized sound rendered in left and right audio channels. In some aspects, the number of sound sources can be determined based on the size of the object. For example, if a window player is small, the window player can represent a single sound source from which the user perceives audio to be emanating from. If, however, the window player is large, then multiple sounds in audio that is associated with the movie player can be rendered at different virtual locations.

For example, if a movie scene has two people speaking at opposite sides of the scene, then voice of each person can be rendered at separate virtual locations when the movie player window is large. If the movie player window is small, then audio of the movie is rendered as a single sound source. In some aspects, the number of channels or layout is determined based on object size. For example, based on a large object size, the channel layout can be determined to be a surround sound layout (e.g., 5.1, 7.2, etc.). For a small object, the channel layout can be mono or stereo.

In some aspects, reverberation of audio is determined based on the object size. A large object can have greater reverberation and a small object can have little or no reverberation. If the object size increases, reverberation of the audio associated with the object can be increased (e.g., proportional to the size of the audio object). If the object size is decreased, then reverberation of the audio associated with the object can be decreased.

In some aspects, a timbre of audio (also known tone quality) is determined based on the object size. Timbre can be mainly determined by the harmonic content of a sound and the dynamic characteristics of the sound such as vibrato and the attack-decay envelope of the sound, frequency spectrum and envelope. Timbre characteristics can be varied based on the size of the object, so that large objects have enhanced tone quality.

It should be understood that the object that is associated with the audio application can be representative of a sound source in a spatial audio environment and/or in an XR environment. Thus, as the object size is increased, the audio associated with the object is modified with audio parameters to make the object sound bigger or smaller. The audio can be spatialized so that it appears to originate from or near the object that is shown to the user. For example, audio associated with a movie player (an object) that is shown to a user will sound as if the audio is emanating from the movie player. In some aspects, the object can represent multiple sound sources, for example, if audio of an application contains more than one sound source (e.g., two people speaking).

It should be understood that the terms small and large can vary based on application, e.g., depending on whether the display is a two display or an XR display, or how big a display is. In some aspects, the audio parameters can be determined proportional to the size of the object. In such a case, the object size is a gradient from small to large. In some aspects, thresholds can be used to determine, in a discrete manner, whether an object is small, medium, large, extra-large, etc. For example, if the object has a dimension (e.g., area, height, width, length, diameter, etc.) smaller than a threshold x, then it is deemed to be small. If the object has a dimension greater than a threshold y, it is deemed to be large. If the object has a dimension than a threshold z, then it is deemed to be extra-large, and so on. The one or more thresholds can be determined based on test and experimentation and can vary from one object or another.

In some aspects, an application can be categorized and these categories can affect how the audio parameters of these applications are treated relative to the object. In some aspects, determining or modifying the audio parameters based on the size of the object can be contingent on a categorization of the application. Categories can include, for example, a media or multi-media category (e.g., movie player, music player, videogames), a communication category (e.g., for phone calls or video chat), and/or a utility (e.g., an alarm clock, camera, a calendar, etc.) category. In some aspects, audio parameters for applications that fall under media are determined dynamically based on object size, while applications in the other categories (e.g., utility or communication) do not have their respective audio parameters determined dynamically based on object size.

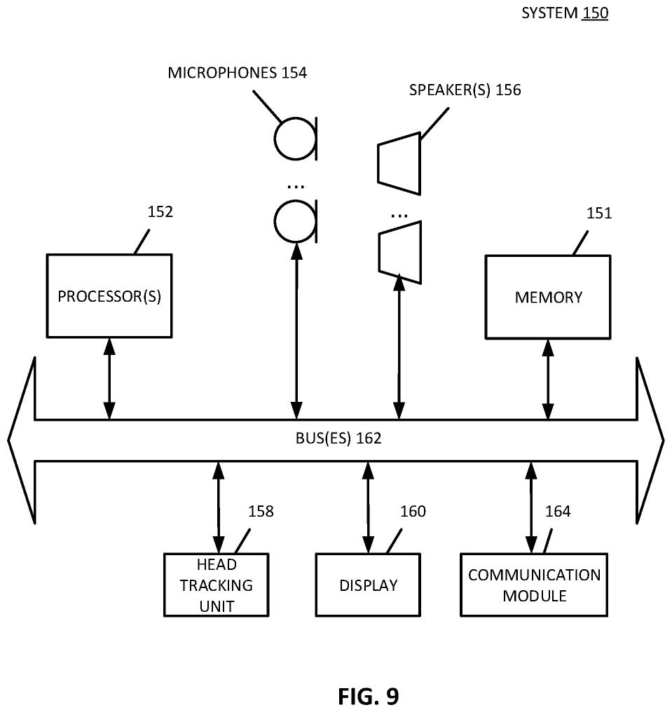

FIG. 9 shows a block diagram of audio processing system hardware, in one aspect, which may be used with any of the aspects described. This audio processing system 150 can represent a general purpose computer system or a special purpose computer system. Note that while the various components of an audio processing system that may be incorporated into headphones, speaker systems, microphone arrays and entertainment systems are shown, it is merely one example of a particular implementation and is merely to illustrate the types of components that may be present in the audio processing system. The system is not intended to represent any particular architecture or manner of interconnecting the components as such details are not germane to the aspects herein. It will also be appreciated that other types of audio processing systems that have fewer or more components than shown can also be used. Accordingly, the processes described herein are not limited to use with the hardware and software shown.

The audio processing system (for example, a laptop computer, a desktop computer, a mobile phone, a smart phone, a tablet computer, a smart speaker, a head mounted display (HMD), a headphone set, or an infotainment system for an automobile or other vehicle) includes one or more buses 162 that serve to interconnect the various components of the system. One or more processors 152 are coupled to bus 162 as is known in the art. The processor(s) may be microprocessors or special purpose processors, system on chip (SOC), a central processing unit, a graphics processing unit, a processor created through an Application Specific Integrated Circuit (ASIC), or combinations thereof. Memory 151 can include Read Only Memory (ROM), volatile memory, and non-volatile memory, or combinations thereof, coupled to the bus using techniques known in the art. A head tracking unit 158 can include an IMU (e.g., gyroscope and/or accelerometers) and/or camera (e.g., RGB camera, RGBD camera, depth camera, etc.) and tracking algorithms that are applied to sensed data to determine position or location of a user. The audio processing system can further include a display 160 (e.g., an HMD, HUD, a computer monitor, a television, or touchscreen display).

Memory 151 can be connected to the bus and can include DRAM, a hard disk drive or a flash memory or a magnetic optical drive or magnetic memory or an optical drive or other types of memory systems that maintain data even after power is removed from the system. In one aspect, the processor 152 retrieves computer program instructions stored in a machine readable storage medium (memory) and executes those instructions to perform operations described herein.

Audio hardware, although not shown, can be coupled to the one or more buses 162 in order to receive audio signals to be processed and output by speakers 156. Audio hardware can include digital to analog and/or analog to digital converters. Audio hardware can also include audio amplifiers and filters. The audio hardware can also interface with microphones 154 (e.g., microphone arrays) to receive audio signals (whether analog or digital), digitize them if necessary, and communicate the signals to the bus 162.

Communication module 164 can communicate with remote devices and networks. For example, communication module 164 can communicate over known technologies such as Wi-Fi, 3G, 4G, 5G, Bluetooth, ZigBee, or other equivalent technologies. The communication module can include wired or wireless transmitters and receivers that can communicate (e.g., receive and transmit data) with networked devices such as servers (e.g., the cloud) and/or other devices such as remote speakers and remote microphones.

It will be appreciated that the aspects disclosed herein can utilize memory that is remote from the system, such as a network storage device which is coupled to the audio processing system through a network interface such as a modem or Ethernet interface. The buses 162 can be connected to each other through various bridges, controllers and/or adapters as is well known in the art. In one aspect, one or more network device(s) can be coupled to the bus 162. The network device(s) can be wired network devices (e.g., Ethernet) or wireless network devices (e.g., WI-FI, Bluetooth). In some aspects, various aspects described (e.g., simulation, analysis, estimation, modeling, object detection, etc.,) can be performed by a networked server in communication with the capture device.

FIG. 10 shows an example of generating sound based on a model of a sound source that can be performed at operation 14, according to some aspects. A model of a sound source 180 can be determined by defining a shape of the model such as, for example, a sphere, cone, cuboid, cylinder, pyramid, a square, a circle, or an irregular shape. In some aspects, one or more portions 184 of the model are defined that radiate acoustic energy, such as in a form of a directivity pattern 182. For example, a cap on a spherical model can radiate acoustic energy.

A shape of the directivity pattern, which can include the shape, direction, and/or number of lobes of the directivity pattern, can be determined based on the geometry and/or size of a) the model, and/or b) the one or more portions that radiates acoustic energy. The directivity pattern can be determined through acoustic simulation of the sound source 180 in virtual environment (e.g., a room). For example, the larger the model of the sound source, the more complicated the directivity pattern can be become (e.g., having increased directivity and/or larger quantity of lobes).

Different sound sources can be modeled differently. Further, some models can have multiple portions that produce sound. For example, if the sound source is a person, the model can have a first portion that vibrates at a first frequency (e.g., approximating a mouth), and a second portion that vibrates at a lower frequency (e.g., approximating the throat). In other examples, a sound source such as a vehicle can be modeled with a first portion that vibrates like an engine and a second portion that vibrates like an exhaust. Thus, a model can have one or more portions that produce sound differently.

From the acoustic simulation with the model, audio filters 190 can be extracted and applied to one or more audio signals to produce an output audio having directivity pattern 182. In some aspects, the audio filters include a) a first filter that is associated with direct sound (to model sound travel from the source directly to the listener), b) a second filter that is associated with early reflections (to model sound that typically reflects off one or two surfaces before arriving at the listener), and c) a third filter that is associated with reverberation (to model sound that arrives at a listener after multiple bounces off of surfaces, typically after 100 ms from the origin of the sound). The filters can define frequency response (e.g., magnitude and phase) for different frequencies at different directions relative to a listener.

In some aspects, the model of the sound source, which can be described as a ‘physical model’, is associated with an object 190. The object can be a visual representation of the sound source that the model is modelling. For example, the object can be a graphic, a video, an animation, an avatar, etc. The sound source can be any sound source such as a loudspeaker, a person, an animal, a movie, a computer application, a videogame, a vehicle, etc. As described the object can be presented in an ER setting and/or on a traditional two-dimensional display.

The model of the sound source can be determined and/or modified based on the object. For example, depending on the orientation, size, or type of the object, the geometry or size of the model can be determined. If the orientation or size of the object changes (e.g., based on input from a user, or an automated action taken by the operating system), then the model can be modified accordingly, thus resulting in another (e.g., a second or modified) set of audio filters. The adjustment of the model can attempt to realistically follow the adjustment of the object that represents the sound source. A reduction in size of the object can result in a reduction in size of the model Similarly, an increase in size of the object can result in an increase in size of the model. For example, a 50% increase or decrease in size of the sound source or object can result in a 50% increase or decrease in size of the physical model. The model can be changed proportionate to a change in the object. In some embodiments, the mapping between the model and the object can be defined (e.g., in user settings), thus allowing for a user to artistically define the relationship between the model and the object.

In some aspects, geometrical attributes of the model can be exposed to a user. For example, the user can configure settings that define the size, shape, or direction of the model. In some aspects, a user can configure the portion of the model that radiates acoustic energy, such as its size, shape, quantity, and/or location on the model. Audio filters can be generated based on the modified geometrical attributes. As such, the user can tune the model according to taste or application.

Thus, based on size or geometry of the model (or of the object that the model is associated with), audio filters 190 are determined. These audio filters can be applied to render audio associated with the sound source. For example, referring to FIG. 2, the spatial audio controller 22 can model the sound source and produce the audio filters. The spatial audio mix engine 26 can then apply those audio filters to audio content to produce spatial audio content (e.g., binaural audio, etc.). The audio channels of the spatial audio content can be used to drive speakers 30.

Similar to the discussion in other sections, the modeling of the sound source can be associated with an application that is managed by an OS. Thus, an application can have an object that visually represents the application as well as sound of the application. The sound of the application can be modeled to automatically produce audio filters that can vary depending on the geometry and/or size of the model, which can be determined based on the geometry, type, or size of the object. Thus, different applications that are managed by the OS can each have corresponding models. A movie application may have a different model than a conferencing application. Further, in some aspects, audio for some sound sources and/or applications are produced using a model, while others are produced ‘artistically’, as described in other sections, without using a model. In some aspects, audio for some sound sources and/or applications can be produced using both a model as described with respect to FIG. 10 and artistically with audio parameters selected as described in other sections. For example, a change in size of a virtual character can cause a corresponding change in the physical model used to render sound of the character, resulting in a change in the reverb properties of the character's voice. Additionally, an audio parameter can be selected (e.g., based on input from a user or a setting) based on the changed size of the virtual character, resulting in a change in pitch of the character's voice. It should be understood that a change to the ‘size’ of an object that represents a sound source (e.g., a virtual character, an application window, etc.) includes a change to the geometry of the object (e.g., a length, width, or change in shape).

Various aspects described herein may be embodied, at least in part, in software. That is, the techniques may be carried out in an audio processing system in response to its processor executing a sequence of instructions contained in a storage medium, such as a non-transitory machine-readable storage medium (e.g. DRAM or flash memory). In various aspects, hardwired circuitry may be used in combination with software instructions to implement the techniques described herein. Thus the techniques are not limited to any specific combination of hardware circuitry and software, or to any particular source for the instructions executed by the audio processing system.

In the description, certain terminology is used to describe features of various aspects. For example, in certain situations, the terms “manager”, “application”, “engine”, controller”, “module”, “processor”, “unit”, “renderer”, “system”, “device”, “filter”, “localizer”, and “component,” are representative of hardware and/or software configured to perform one or more processes or functions. For instance, examples of “hardware” include, but are not limited or restricted to an integrated circuit such as a processor (e.g., a digital signal processor, microprocessor, application specific integrated circuit, a micro-controller, etc.). Thus, different combinations of hardware and/or software can be implemented to perform the processes or functions described by the above terms, as understood by one skilled in the art. Of course, the hardware may be alternatively implemented as a finite state machine or even combinatorial logic. An example of “software” includes executable code in the form of an application, an applet, a routine or even a series of instructions. As mentioned above, the software may be stored in any type of machine-readable medium.

Some portions of the preceding detailed descriptions have been presented in terms of algorithms and symbolic representations of operations on data bits within a computer memory. These algorithmic descriptions and representations are the ways used by those skilled in the audio processing arts to most effectively convey the substance of their work to others skilled in the art. An algorithm is here, and generally, conceived to be a self-consistent sequence of operations leading to a desired result. The operations are those requiring physical manipulations of physical quantities. It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of an audio processing system, or similar electronic device, that manipulates and transforms data represented as physical (electronic) quantities within the system's registers and memories into other data similarly represented as physical quantities within the system memories or registers or other such information storage, transmission or display devices.

The processes and blocks described herein are not limited to the specific examples described and are not limited to the specific orders used as examples herein. Rather, any of the processing blocks may be re-ordered, combined or removed, performed in parallel or in serial, as necessary, to achieve the results set forth above. The processing blocks associated with implementing the audio processing system may be performed by one or more programmable processors executing one or more computer programs stored on a non-transitory computer readable storage medium to perform the functions of the system. All or part of the audio processing system may be implemented as, special purpose logic circuitry (e.g., an FPGA (field-programmable gate array) and/or an ASIC (application-specific integrated circuit)). All or part of the audio system may be implemented using electronic hardware circuitry that include electronic devices such as, for example, at least one of a processor, a memory, a programmable logic device or a logic gate. Further, processes can be implemented in any combination hardware devices and software components.

While certain aspects have been described and shown in the accompanying drawings, it is to be understood that such aspects are merely illustrative of and not restrictive on the broad invention, and the invention is not limited to the specific constructions and arrangements shown and described, since various other modifications may occur to those of ordinary skill in the art.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A method performed by a computing device, comprising:
maintaining metadata associated with an application running on the computing device, the metadata including a size of an object that is associated with the application;
presenting the object associated with the application; and
based on the size of the object, determining one or more audio parameters that includes a dynamic range that is applied to render audio associated with the application.

2. The method of claim 1, further comprising increasing the dynamic range if the size of the object increases, and decreasing the dynamic range if the size of the object decreases.

3. The method of claim 1, where determining the dynamic range includes generating audio filters based on a model of a sound source that is associated with the object.

4. The method of claim 3, wherein a size or geometry of the model is determined based on a size or geometry of the object.

5. The method of claim 4, further comprising modifying the size or the geometry of the model in response to a change in the size or the geometry of the object.

6. The method of claim 3, wherein one or more portions of the model radiates acoustic energy in simulation which determines the dynamic range, the audio filters being generated from the acoustic energy.

7. The method of claim 3, wherein the audio filters include a first filter associated with direct sound, a second filter associated with early reflections, and third filter associated with a reverberation, that are applied to the audio to render the audio.

8. The method of claim 3, comprising modifying geometrical attributes of the model based on user input, resulting in generating of second audio filters based on the modified geometrical attributes of the model.

9. The method of claim 1, wherein the one or more audio parameters further comprises at least one of: a directivity pattern, a frequency response, a sound power, a frequency range, a pitch, a timbre, a number of output audio channels, and a reverberation.

10. The method of claim 9, further comprising, modifying at least one of the one or more audio parameters if the size of the object is modified.

11. The method of claim 1, wherein the object is presented through an augmented reality, mixed reality, or virtual reality display.

12. The method of claim 1, wherein the object is presented through a two-dimensional display.

13. The method of claim 1, wherein applying of the dynamic range is independent of user-controlled audio settings that are used to render audio associated with the application.

14. The method of claim 1 wherein the method is performed by an operating system (OS) of the computing device and the application is one of a plurality of applications managed by the OS, each of the plurality of applications being associated with corresponding metadata that includes a corresponding size of a corresponding object.

15. The method of claim 14, wherein, based on the corresponding size of the corresponding object, an audio parameter that is associated with a corresponding one of the plurality of applications is determined and is applied to render audio associated with the corresponding one of the plurality of applications.

16. The method of claim 1, wherein determining or modifying the dynamic range or other audio parameters based on the size of the object is contingent on a categorization of the application, the categorization including at least one of: media, communication, and utility.

17. A method performed by a computing device, comprising:
maintaining metadata associated with an application running on the computing device, the metadata including a size of an object that is associated with the application;
presenting the object associated with the application; and
based on the size of the object, determining one or more audio parameters that includes a directivity pattern that is applied to render audio associated with the application.

18-32. (canceled)

33. A method performed by a computing device, comprising:
maintaining metadata associated with an application running on the computing device, the metadata including a size of an object that is associated with the application;
presenting the object associated with the application; and
based on the size of the object, determining at least one of a plurality of audio parameters that includes a frequency response that is applied to render audio associated with the application.

34.-75. (canceled)
